(19) United States
(12) Patent Application Publication
(10) Pub. No.: US 2026/0142870 A1
(43) Pub. Date: May 21, 2026

(54) SYSTEM, COMPUTER-IMPLEMENTED METHOD, AND NON-TRANSITORY COMPUTER-READABLE STORAGE MEDIUM

(71) Applicant: NINTENDO CO., LTD., Kyoto-shi (JP)

(72) Inventors: Taiyo WATANABE, Kyoto-shi (JP); Masayuki SHAMOTO, Kyoto-shi (JP); Masahiro YOSHINO, Kyoto-shi (JP); Ami HAYASHI, Kyoto-shi (JP); Ryo YAEGASHI, Kyoto-shi (JP); Hitoshi SAKAI, Kyoto-shi (JP)

(21) Appl. No.: 19/370,080

(22) Filed: Oct. 27, 2025

(30) Foreign Application Priority Data
Nov. 21, 2024 (JP) 2024-203051

(51) Int. Cl. H04L 41/0686

(52) U.S. Cl. CPC H04L 41/0686

(57) ABSTRACT

A system comprises a first terminal, a second terminal, a first server, and a second server. In the system, the first server performs first processing comprising causing the second server that is configured to persistently be connected to the second terminal to give a first notification to the second terminal in accordance with a user operation on the first terminal, and the second server can receive from the second terminal, a first response indicating that the second terminal has received the first notification, and transmits to the first server, a second response indicating successful delivery of the first notification or a third response indicating that the first notification has failed, in accordance with whether or not it has received the first response.

This non-provisional application is based on Japanese Patent Application No. 2024-203051 filed with the Japan Patent Office on Nov. 21, 2024, the entire contents of which are hereby incorporated by reference.

### FIELD

The present disclosure relates to a system, a computer-implemented method, and a non-transitory computer-readable storage medium.

### BACKGROUND AND SUMMARY

A technique to change setting of a game terminal from a terminal such as a smartphone, with a server being interposed, has been known.

In an example where a notification based on a user operation on a certain terminal is given to another terminal, when that another terminal is unable to receive the notification, the fact that another terminal is unable to receive the notification is desirably notified earlier of a user who operates the certain terminal.

### Configuration 1

An exemplary embodiment provides a system comprising a first terminal, a second terminal, a first server, and a second server. The first server performs first processing comprising causing the second server that is configured to persistently be connected to the second terminal to give a first notification to the second terminal, in accordance with a user operation on the first terminal. The second server can receive from the second terminal, a first response indicating that the second terminal has received the first notification, and transmits to the first server, a second response indicating successful delivery of the first notification or a third response indicating that the first notification has failed, in accordance with whether the second server has received the first response.

### Configuration 2

In Configuration 1, the third response comprises information indicating a cause of failure to deliver the first notification.

### Configuration 3

In Configuration 1 or 2, in transmission of the third response to the first server, the second server transmits the third response after lapse of a prescribed period when the second terminal is persistently connected to the second server, and transmits the third response before lapse of the prescribed period when the second terminal is not persistently connected to the second server.

### Configuration 4

In any of Configurations 1 to 3, when the first server has received the third response from the second server, the first server causes the first terminal to give a notice, and when the first server has received the second response from the second server, the first server omits the notice to a user by the first terminal.

### Configuration 5

In any of Configurations 1 to 4, the second terminal is configured such that a virtual game card is insertable therein, and the first processing comprises processing for insertion of the virtual game card in the second terminal or processing for removal of the virtual game card from the second terminal.

### Configuration 6

In any of Configurations 1 to 5, the first server performs second processing comprising causing the second server to give a second notification to the second terminal, in accordance with a user operation on the first terminal, holds a session with the second server when a request is issued to the second server in the first processing, and quits the session with the second server when a request is issued to the second server in the second processing.

### Configuration 7

In Configuration 6, the second server does not give the first server a notification indicating a result as to whether or not the second notification has been successful, based on reception of the request for the second processing, regardless of whether or not the second notification has been successful.

### Configuration 8

In Configuration 6 or 7, the second server omits adding the first notification to a queue but adds the second notification to the queue.

### Configuration 9

Another exemplary embodiment provides a computer-implemented method to be used in a system where a first terminal and a second terminal communicate with a first server and a second server being interposed, and the computer-implemented method comprises performing, at the first server, first processing comprising causing the second server that is configured to persistently be connected to the second terminal to give a first notification to the second terminal, in accordance with a user operation on the first terminal, receiving from the second terminal, at the second server, a first response indicating that the second terminal has received the first notification, and transmitting to the first server, at the second server, a second response indicating successful delivery of the first notification or a third response indicating that the first notification has failed, in accordance with whether the second server has received the first response.

### Configuration 10

In Configuration 9, the third response comprises information indicating a cause of failure to deliver the first notification.

### Configuration 11

In Configuration 9 or 10, the computer-implemented method comprises, in transmission of the third response to the first server at the second server, transmitting, at the second server, the third response after lapse of a prescribed period when the second terminal is persistently connected to the second server and transmitting, at the second server, the third response before lapse of the prescribed period when the second terminal is not persistently connected to the second server.

### Configuration 12

In any of Configurations 9 to 11, the computer-implemented method comprises causing the first terminal to give a notice when the first server has received the third response from the second server, and omitting, at the first server, the notice to a user by the first terminal when the first server has received the second response from the second server.

### Configuration 13

In any of Configurations 9 to 12, the second terminal is configured such that a virtual game card is insertable therein, and the first processing comprises processing for insertion of the virtual game card in the second terminal or processing for removal of the virtual game card from the second terminal.

### Configuration 14

In any of Configurations 9 to 13, the computer-implemented method comprises performing, at the first server, second processing comprising causing the second server to give a second notification to the second terminal, in accordance with a user operation on the first terminal, holding, at the first server, a session with the second server when the second server is requested to perform the first processing, and quitting, at the first server, the session with the second server based on the fact that the second server is requested to perform the second processing.

### Configuration 15

In Configuration 14, the computer-implemented method comprises omitting, at the second server, a notification to the first server that indicates that the second notification has been successful, based on reception of a request for the second processing, even when the second notification has been successful.

### Configuration 16

In Configuration 14 or 15, the computer-implemented method further comprises omitting, at the second server, adding the first notification to a queue but adding, at the second server, the second notification to the queue.

### Configuration 17

Another exemplary embodiment provides a program to be used in a second server that is configured to persistently be connected to a second terminal and comprises one or more processors in a system where a first terminal and the second terminal communicate with a first server and the second server being interposed, and the program causes the one or more processors to perform giving a first notification to the second terminal based on first processing performed by the first server, in accordance with a user operation on the first terminal, receiving from the second terminal, a first response indicating that the second terminal has received the first notification, and transmitting to the first server, a second response indicating successful delivery of the first notification or a third response indicating that the first notification has failed, in accordance with whether the second server has received the first response.

### Configuration 18

In Configuration 17, the third response comprises information indicating a cause indicating failure of the first notification.

### Configuration 19

In Configuration 17 or 18, the program causes the one or more processors to perform, in transmission of the third response to the first server at the second server, transmitting the third response after lapse of a prescribed period when the second terminal is persistently connected to the second server and transmitting the third response before lapse of the prescribed period when the second terminal is not persistently connected to the second server.

### Configuration 20

In any of Configurations 17 to 19, the second terminal is configured such that a virtual game card is insertable therein, and the first processing comprises processing for insertion of the virtual game card in the second terminal or processing for removal of the virtual game card from the second terminal.

### Configuration 21

In any of Configurations 17 to 20, the program causes the one or more processors to perform giving a second notification to the second terminal based on second processing performed by the first server, in accordance with a user operation on the first terminal, holding a session with the first server when a request for the first processing is accepted from the first server, and quitting the session with the first server when a request for the second processing is accepted from the first server.

### Configuration 22

In Configuration 21, the program causes the one or more processors to perform omitting a notification to the first server that indicates that the second notification has been successful, based on reception of the request for the second processing, even when the second notification has been successful.

### Configuration 23

In Configuration 22, the program causes the one or more processors to perform omitting adding the first notification to a queue but adding the second notification to the queue.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary system according to the present embodiment.

FIG. 2 shows an exemplary illustrative non-limiting drawing illustrating an exemplary hardware configuration of a persistent connection server according to the present embodiment.

FIG. 3 shows an exemplary illustrative non-limiting drawing illustrating an exemplary hardware configuration of a game terminal according to the present embodiment.

FIG. 4 shows an exemplary illustrative non-limiting drawing illustrating an exemplary hardware configuration of a service providing server according to the present embodiment.

FIG. 5 shows an exemplary illustrative non-limiting drawing illustrating an exemplary flowchart for illustrating exemplary processing for an API request by the service providing server in a first embodiment.

FIG. 6 shows an exemplary illustrative non-limiting drawing illustrating an exemplary sequence for illustrating an example where a notification from the persistent connection server to the game terminal is successful.

FIG. 7 shows an exemplary illustrative non-limiting drawing illustrating an exemplary sequence for illustrating an example where a notification from the persistent connection server to the game terminal fails.

FIG. 8 shows an exemplary illustrative non-limiting drawing illustrating an exemplary flowchart for illustrating exemplary processing for an API request by the service providing server in a second embodiment.

FIG. 9 shows an exemplary illustrative non-limiting drawing illustrating an exemplary sequence for illustrating an example where setting change processing is successful in communication in a second mode.

FIG. 10 shows an exemplary illustrative non-limiting drawing illustrating an exemplary sequence for illustrating an example where setting change processing fails in communication in the second mode.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### First Embodiment

### A. Overview

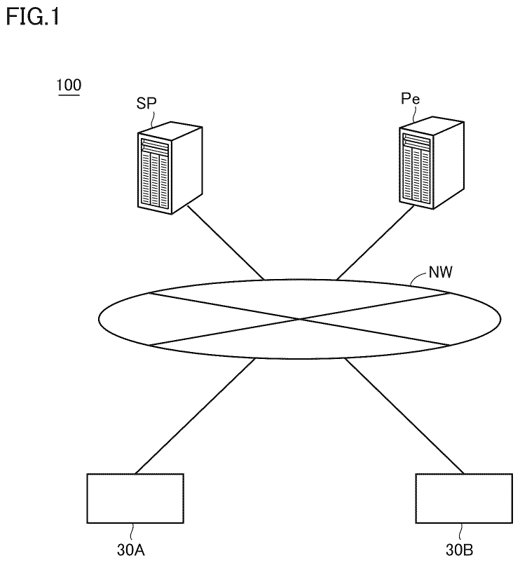

An exemplary configuration of a system 100 according to the present embodiment will be described. Exemplary system 100 according to the present embodiment will be described with reference to FIG. 1. System 100 is a system that provides a service to game terminals 30A and 30B, not-shown other information terminals, and the like, for example, with a persistent connection server Pe and a service providing server SP.

System 100 includes game terminals 30A and 30B, service providing server SP, and persistent connection server Pe, by way of example. Elements included in system 100 are connectable to one another over a network NW. Network NW is, for example, the Internet.

Each of game terminals 30A and 30B may be, for example, an information processing apparatus exclusive for gaming. Game terminals 30A and 30B will collectively be referred to as a “game terminal 30” below without being distinguished from each other.

In the present embodiment, persistent connection server Pe provides a persistent connection service. The persistent connection service is, for example, a service for enabling at any timing, by maintaining connection between persistent connection server Pe and game terminal 30, communication between persistent connection server Pe and game terminal 30 connection to which is maintained. The persistent connection service provides such a connection scheme that game terminal 30 persistently keeps maintaining connection to persistent connection server Pe while game terminal 30 is connectable to network NW. A state in which connection between persistent connection server Pe and game terminal 30 is held will be referred to as a “persistently connected state” below. For example, when a predetermined condition is satisfied, persistent connection server Pe may give a notification in accordance with the condition to game terminal 30 in the persistently connected state. Game terminal 30 may be configured to basically be in the persistently connected state when it is connected to network NW or configured to be in the persistently connected state based on a predetermined condition such as a user operation.

In the present embodiment, service providing server SP is a server that performs processing specialized in a specific service. The specific service may be various services such as a service to have a plurality of game terminals 30 exchange information, a service to have not-shown another information processing terminal or the like manage a state of game terminal 30, and a service to change a program in a plurality of game terminals 30 in accordance with an instruction from a development terminal. The service to be provided by service providing server SP is not limited thereto, and may be other services. The persistent connection service provided by persistent connection server Pe and the specific service provided by service providing server SP are services independent of each other.

An example in which the service provided by service providing server SP is a virtual game card service will be described in a first embodiment. The virtual game card service is, for example, a service that virtually realizes a such a form of use as selective insertion and use of a single game card among a plurality of game terminals 30. The virtual game card service may be a service that provides processing for inserting the virtual game card in game terminal 30 or processing for removing the virtual game card from game terminal 30.

### B. Exemplary Hardware Configuration

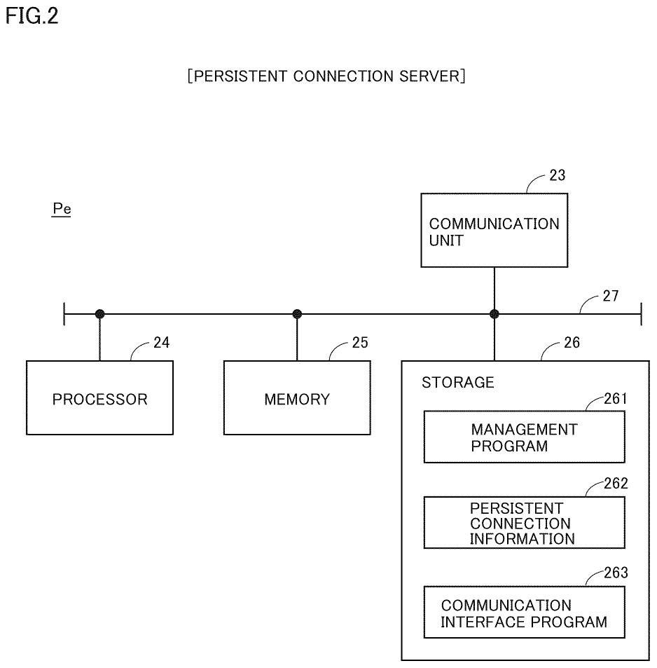

An exemplary hardware configuration of persistent connection server Pe, game terminal 30, and service providing server SP included in system 100 according to the present embodiment will be described below with reference to FIGS. 2 to 4.

An exemplary hardware configuration of persistent connection server Pe according to the present embodiment will be described with reference to FIG. 2. Referring to FIG. 2, persistent connection server Pe includes a communication unit 23, one or more processors 24, a memory 25, and a storage 26. These components are connected to communicate data with one another through a bus 27. Persistent connection server Pe may be a server exclusively for providing the persistent connection service, may be implemented by a general-purpose server, or may be configured with combination of a plurality of information processing terminals.

Communication unit 23 communicates with other information processing terminals included in system 100 over network NW. Communication unit 23 may be provided with at least one of hardware necessary for wired communication and hardware necessary for wireless communication. The entirety or a part of processing by communication unit 23 may be performed by processor 24.

Processor 24 is a processing entity for performing processing provided by persistent connection server Pe. The term “processor” in the present disclosure means processing circuitry such as a central processing unit (CPU), a micro processing unit (MPU), or a graphics processing unit (GPU). The term “processor” encompasses processing circuitry that performs processing in accordance with instruction codes described in a program, processing circuitry in which a plurality of functions are integrated, such as a system on chip (SoC), hard-wired circuitry, and the like.

Memory 25 is a volatile storage device accessible by processor 24, and for example, a dynamic random access memory (DRAM), a static random access memory (SRAM), or the like may be employed as memory 25. Storage 26 is a non-volatile storage device accessible by processor 24, and for example, a hard disk, a flash memory, or the like may be employed as storage 26. Storage 26 may be, for example, a storage medium attachable to and removable from persistent connection server Pe, such as an optical disc and a cartridge.

A management program 261, persistent connection information 262, and a communication interface program 263 may be stored in storage 26. Processor 24 reads, for example, management program 261 or communication interface program 263 and develops and executes the same on memory 25. The term “memory” herein encompasses at least both of a volatile memory and a non-volatile storage.

Management program 261 is, for example, a program for management of game terminal 30 in the persistently connected state. Management program 261 may include processing for causing persistent connection server Pe to give a notification to game terminal 30 in the persistently connected state.

Persistent connection information 262 is information that allows specifying of game terminal 30 in the persistently connected state. For example, persistent connection information 262 may be a table for management of identification information of game terminal 30 in the persistently connected state. Game terminal 30 is or is not in the persistently connected state, depending on timing. For example, game terminal 30 may be in a state which is not the persistently connected state when power is OFF, when it is not connected to network NW, or when it accepts an instruction not to be connected to persistent connection server Pe from a user. Persistent connection server Pe obtains the identification information of game terminal 30 in the persistently connected state, for example, every prescribed period, and updates persistent connection information 262.

Communication interface program 263 is a program for realizing an application programming interface (API) for providing a function of persistent connection server Pe to the outside. For example, the API is published to a user, a developer, or the like as information for allowing another information processing terminal to use the function of persistent connection server Pe. In the present embodiment, persistent connection server Pe accepts a request for use of the function thereof from another information processing terminal via the API. For example, based on acceptance of a request from service providing server SP via the API, persistent connection server Pe may give a notification in accordance with contents of the request from service providing server SP to game terminal 30 in the persistently connected state. Persistent connection server Pe that has received an API request which will be described in the first embodiment may hold a session with an information processing terminal that has issued the API request after it receives the API request.

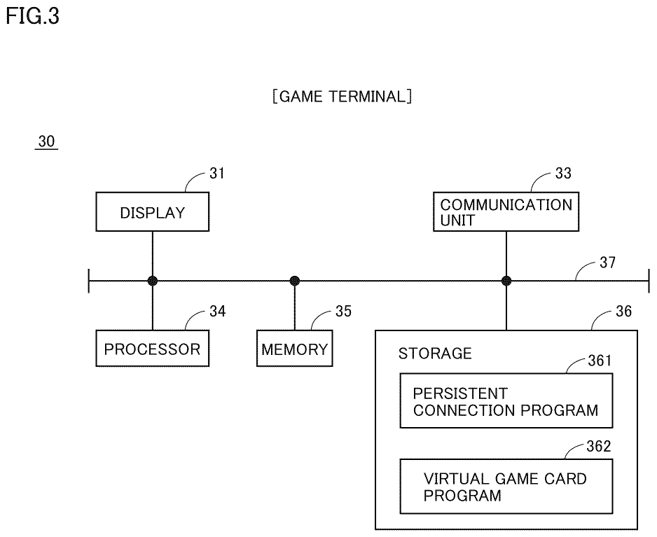

An exemplary hardware configuration of game terminal 30 according to the present embodiment will be described with reference to FIG. 3. Game terminal 30 includes a display 31, a communication unit 33, one or more processors 34, a memory 35, and a storage 36 that are connected to communicate data with one another through a bus 37.

A persistent connection program 361 is a program for using the persistent connection service. Game terminal 30 may execute, for example, persistent connection program 361 so as to be controlled to the persistently connected state or so as to perform processing in accordance with a notification received from persistent connection server Pe while it is in the persistently connected state.

Virtual game card program 362 is a program for using the virtual game card service. Processing performed by virtual game card program 362 may include, for example, at least one of processing for setting a state of game terminal 30 itself to a state in which a certain virtual game card has been inserted therein and setting processing for setting the state to a state in which the virtual game card has been removed therefrom. The setting processing may be performed based on a user operation on game terminal 30 itself or in response to a request from another information processing terminal including service providing server SP.

Game terminal 30 executes, for example, virtual game card program 362 to determine whether or not it has the right to execute the virtual game card. When game terminal 30 is in the state in which the certain virtual game card has been inserted therein, it may determine that it has the right to execute the virtual game card and may execute the virtual game card in accordance with the user operation. When game terminal 30 is in the state in which the certain virtual game card has not been inserted therein, it may determine that it does not have the right to execute the virtual game card to thereby prohibit execution of the virtual game card or erase a program and data for execution of the virtual game card from storage 36.

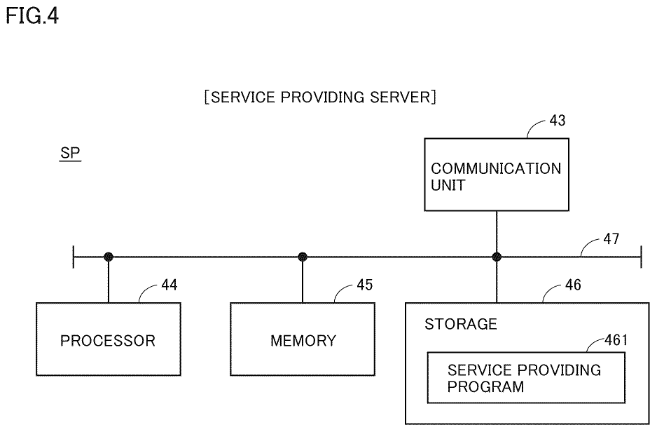

An exemplary hardware configuration of service providing server SP according to the present embodiment will be described with reference to FIG. 4. Referring to FIG. 4, service providing server SP includes a communication unit 43, one or more processors 44, a memory 45, and a storage 46 that are connected to communicate data with one another through a bus 47. Service providing server SP may be a server exclusively for providing a specific service, may be implemented by a general-purpose server, or may be configured with combination of a plurality of information processing apparatuses.

A service providing program 461 is a program for performing a specific service provided by service providing server SP. The specific service may be, for example, a service including giving a notification to at least one game terminal 30. Since the specific service in the first embodiment is the virtual game card service, service providing server SP manages a state of insertion of the virtual game card in game terminal 30. Service providing server SP may execute service providing program 461 to cause certain game terminal 30 to perform the setting processing described above.

In the first embodiment, service providing server SP provides, for example, a service to remotely insert or remove the virtual game card in or from another game terminal 30 in accordance with a user operation on a certain information processing terminal. At this time, service providing server SP in the first embodiment uses the function of persistent connection server Pe by issuing an API request, in order to give a notification to cause a target game terminal 30 to perform the setting processing. In other words, persistent connection server Pe provides service providing server SP with a function to transmit a notification including an instruction to perform the setting processing, with target game terminal 30 being designated as a destination. Though the setting processing is processing for changing setting of the state of insertion of the virtual game card in certain game terminal 30 in the first embodiment, the setting processing is not limited thereto. The setting processing may be different based on contents or the like of the specific service provided by service providing server SP. For example, in an example where the specific service is a watch service to supervise game terminal 30, the setting processing may be setting of play limit time of game terminal 30, setting of a password for changing the limit time, or the like.

### C. Exemplary Processing for API Request

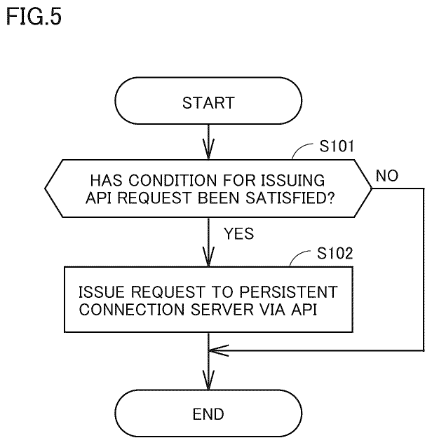

An exemplary flowchart for illustrating exemplary processing for an API request by service providing server SP in the first embodiment will be described with reference to FIG. 5. Service providing server SP determines whether or not a condition for issuing a request via the API to persistent connection server Pe has been satisfied (step S101). The condition for issuing the request via the API may be, for example, acceptance of a service request to cause game terminal 30 to perform the setting processing from another information processing terminal. When the condition has not been satisfied (NO in step S101), service providing server SP quits the process.

When the condition has been satisfied (YES in step S101), service providing server SP issues the request via the API to persistent connection server Pe (step S102) and quits the process. In step S102, service providing server SP transmits to persistent connection server Pe, destination information of game terminal 30 to which a notification is to be sent and contents of the notification.

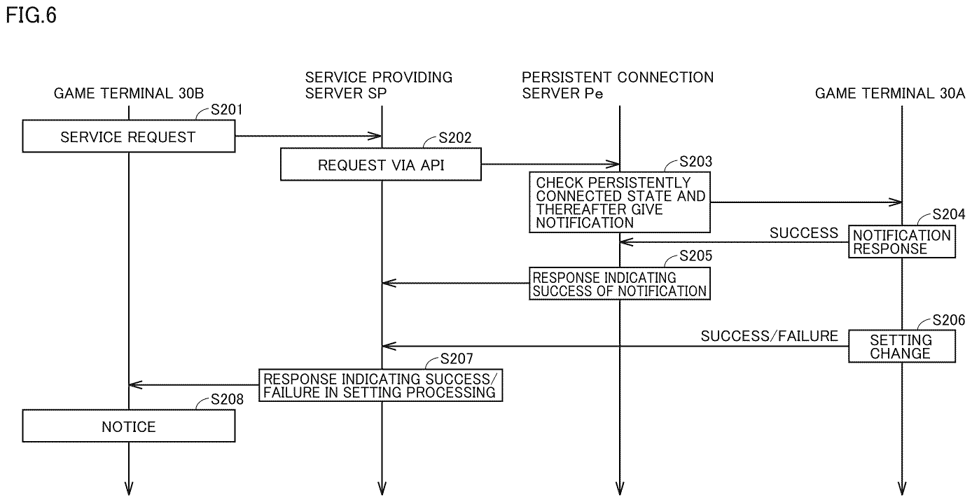

In succession, a specific case will be described with reference to a sequence diagram. FIGS. 6 to 8 below illustrate an example in which service providing server SP receives a request in connection with the virtual game card service from game terminal 30B by way of example. The request in connection with the virtual game card service from game terminal 30B includes contents that request removal of a specific virtual game card that has been inserted in game terminal 30A. In this case, game terminal 30A is notified of an instruction to perform the setting processing for setting to the state in which the specific virtual game card has been removed therefrom. As described above, the setting processing may be processing other than the processing for setting to the state in which the specific virtual game card has been removed, or the specific service provided by service providing server SP may also be another service.

An exemplary sequence for illustrating an example where a notification from persistent connection server Pe to game terminal 30A is successful will be described with reference to FIG. 6. Game terminal 30B issues to service providing server SP, for example, a service request for the service or the like that requests removal of the specific virtual game card that has been inserted in game terminal 30A (step S201). Service providing server SP that has received the service request issues the request via the API, in order to use the function of persistent connection server Pe (step S202). In step S202, service providing server SP transmits to persistent connection server Pe, destination information indicating game terminal 30A and notification contents, for example, that the setting processing for removing the virtual game card is to be performed. In the first embodiment, persistent connection server Pe holds a session with service providing server SP also after step S202.

Persistent connection server Pe checks whether or not game terminal 30A indicated in the received destination information is in the persistently connected state based on reception of the request via the API, for example, by referring to persistent connection information 262. In an example in FIG. 6, persistent connection server Pe confirms that game terminal 30A is in the persistently connected state. After persistent connection server Pe confirms the persistently connected state of game terminal 30A, it gives a notification including an instruction to perform the setting processing (step S203).

Game terminal 30A in the persistently connected state gives a notification response based on reception of the notification from persistent connection server Pe (step S204). The notification response is a response indicating whether or not the notification from persistent connection server Pe to game terminal 30A has been successful. In the example in FIG. 6, game terminal 30A normally receives the notification. Therefore, game terminal 30A gives the notification response, with information indicating that it has normally received the notification being incorporated therein. The notification response in step S204 should only include information that allows specifying of the fact that game terminal 30A has normally received the notification, and it may be an ACK signal by way of example. Persistent connection server Pe gives a response indicating successful delivery of the notification to service providing server SP (step S205). At this time, in the present embodiment, service providing server SP gives no notification to game terminal 30B based on reception of the response in step S205. Service providing server SP may give the response indicating successful delivery of the notification to game terminal 30B based on reception of the response in step S205. The response in step S205 may also be the ACK signal as in step S204.

Exemplary processing for the specific service provided by service providing server SP in steps S206 to S208 will be described below. This processing may be processing independent of the request in S201 and S202, and it does not have to be performed depending on a type of the service or different processing may be performed. Game terminal 30A changes setting in accordance with contents of the notification received in step S203 (step S206). Specifically, in an example where the specific service is the virtual game card service, as a part of use of the virtual game card service, game terminal 30A executes virtual game card program 362 and sets the state of game terminal 30A itself to the state in which the specific virtual game card has been removed therefrom. Game terminal 30A executes, for example, virtual game card program 362 and notifies service providing server SP of a result indicating whether or not the setting processing for removing the specific virtual game card has been successful. Upon reception of the notification indicating whether or not the setting processing has been successful from game terminal 30A, service providing server SP transmits to game terminal 30B, a response indicating that the setting processing has been successful at game terminal 30A (step S207). Game terminal 30B gives a notice of a result indicating whether or not the setting processing has been successful (step S208). In an example of another service, game terminal 30A may issue to service providing server SP, a request for having game terminal 30B give a notice about whether or not processing corresponding to S206 has been successful, with persistent connection server Pe being interposed. Specifically, game terminal 30A may perform prescribed processing, and thereafter transmit information indicating a result of the processing to service providing server SP, and service providing server SP may give a notification to game terminal 30B, with persistent connection server Pe being interposed, in a manner corresponding to steps S202 to S205 described above. Depending on whether or not a terminal corresponding to game terminal 30B is a terminal connectable to persistent connection server Pe, processing from step S206 as above may be switched.

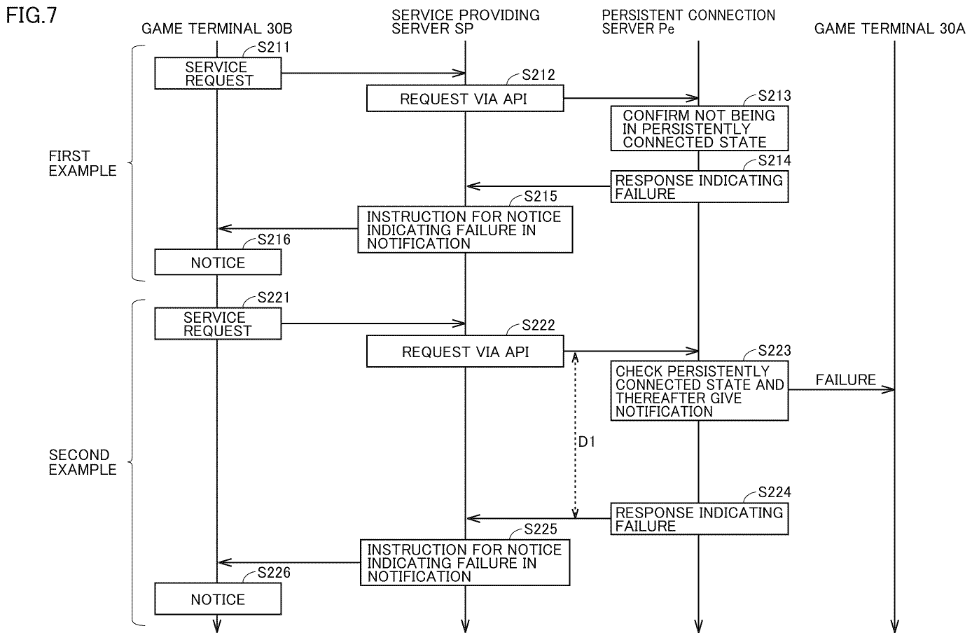

An exemplary sequence for illustrating an example where a notification from persistent connection server Pe to game terminal 30A fails will be described with reference to FIG. 7. FIG. 7 shows a first example and a second example as examples where the notification to game terminal 30A fails.

The first example where the notification to game terminal 30A has failed while game terminal 30A is not in the persistently connected state will be described with reference to steps S211 to S216. The second example where the notification to game terminal 30A has failed while game terminal 30A is in the persistently connected state will be described with reference to steps S221 to S227.

Since processing in steps S211 and S212 corresponds to the processing in steps S201 and S202, description will not be repeated. In the first embodiment, also after step S212, the session between service providing server SP and persistent connection server Pe is held. In step S213, unlike step S203, persistent connection server Pe confirms that game terminal 30A is not in the persistently connected state, for example, by referring to persistent connection information 262 (step S213).

Persistent connection server Pe that has determined that game terminal 30A is not in the persistently connected state transmits to service providing server SP, a response indicating that the notification to game terminal 30A has failed (step S214). Since the session between service providing server SP and persistent connection server Pe is held also after step S212, persistent connection server Pe can perform processing in step S214 in a short period after processing in step S212. This short period may be a period, for example, within 200 ms or the like. An exemplary response in step S214 may be a NACK signal.

Furthermore, service providing server SP transmits to game terminal 30B, an instruction to give a notice indicating failure in notification (step S215). Game terminal 30B gives a notice indicating failure in setting change at game terminal 30A (step S216).

The response indicating failure transmitted in steps S214 and S215 may include information indicating a cause of failure. In the example in steps S214 and S215, for example, the response indicating failure may include information indicating that game terminal 30A was not in the persistently connected state. In step S216, game terminal 30B may give the user a notice of the information indicating the cause of failure.

In succession, the second example where the notification to game terminal 30A has failed while game terminal 30A is in the persistently connected state will be described. Since processing in steps S221 and S222 corresponds to the processing in steps S201 and S202, description will not be repeated.

In step S223, persistent connection server Pe fails in transmission of the notification to game terminal 30A. The cause of failure in transmission of the notification to game terminal 30A in step S223 is, for example, occurrence of some fault at game terminal 30A or network NW in spite of game terminal 30A being in the persistently connected state or game terminal 30A no longer being in the persistently connected state, for example, due to disconnection of game terminal 30A from network NW at the time of start of processing in step S223 in spite of storage of the fact that game terminal 30A is in the persistently connected state in persistent connection information 262. When transmission of the notification from persistent connection server Pe to game terminal 30A fails due to such fault, persistent connection server Pe determines that transmission of the notification has failed, by time-out processing.

When persistent connection server Pe does not accept a notification response from game terminal 30A corresponding to S204 during a period from acceptance of the request via the API from service providing server SP in step S222 until lapse of a period D1, it transmits a response indicating failure (step S224). Period D1 may be, for example, such a period as ten seconds. Since processing in steps S224 to step S226 corresponds to the processing in steps S214 to S216, description will not be repeated. In system 100, game terminal 30B can thus be caused to give a notice about failure of the notification to game terminal 30A. For example, when there is an error in contents of the notification received from persistent connection server Pe, game terminal 30A may transmit to persistent connection server Pe, information indicating failure in reception of the notification. When persistent connection server Pe receives information indicating failure in reception of the notification from game terminal 30A before lapse of period D1, it may transmit a response indicating failure to service providing server SP.

### Second Embodiment

An example where the request for changing the setting of game terminal 30A is issued via the API is described in the first embodiment. The API for using the function of persistent connection server Pe may be configured such that a plurality of types of requests can be accepted. The request via the API described in the first embodiment will be referred to as a “first request” below, and communication described with reference to FIGS. 6 and 7 performed in response to the first request will be referred to as “communication in a first mode” below. Communication when a second request different from the first request which will be described in a second embodiment is issued will be referred to as “communication in a second mode” below.

Unlike communication in the first mode, communication in the second mode may be communication in which, after the second request, the session between persistent connection server Pe and service providing server SP is not held but the session, for example, ends. In the second embodiment, service providing server SP can select between communication in the first mode and communication in the second mode by changing a type of the request via the API. Description of features in the second embodiment the same as those in the first embodiment will not be repeated.

Communication in the second mode may be communication that may be used for a notification directed to game terminals 30 more than game terminals 30 to which a notification is sent in communication in the first mode by way of example. Communication in the second mode may be used, for example, for provision or the like of a service for a developer who performs batch processing for several ten or more game terminals 30 connected to persistent connection server Pe. The batch processing may be, for example, processing for eliminating a bug or the like in a program. In this case, the service provided by service providing server SP may be, for example, a service for a developer who assists maintenance of a plurality of game terminals 30. When persistent connection server Pe gives a notification to game terminals 30 through communication in the second mode, it uses a queue to give the notification to each game terminal 30.

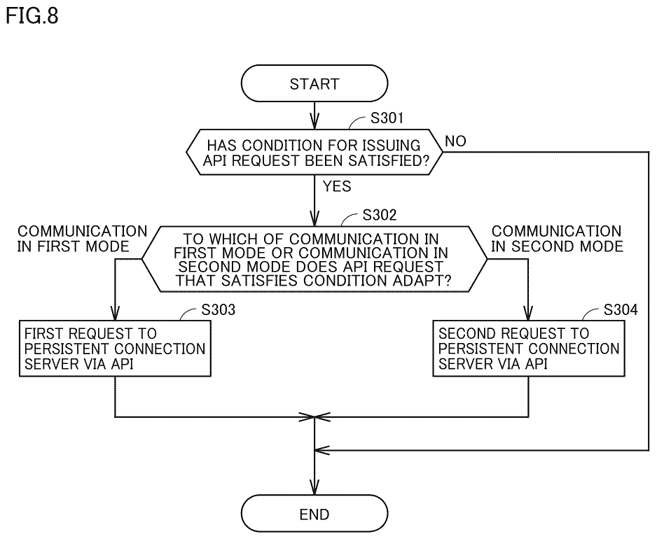

An example in which a developer issues a service request to service providing server SP for causing game terminal 30 in the persistently connected state to perform the batch processing will be described below. An exemplary flowchart for illustrating exemplary processing for the API request by service providing server SP in the second embodiment will be described with reference to FIG. 8. In the second embodiment, service providing server SP performs the flowchart in FIG. 8 instead of the flowchart shown in FIG. 5.

In the second embodiment, when a condition for issuance of a request via the API to persistent connection server Pe has been satisfied (YES in step S301), service providing server SP determines to which of communication in the first mode or communication in the second mode the API request from game terminal 30 satisfied in step S301 adapts (step S302).

To which communication mode the API request adapts may be predetermined in accordance with contents of the API request. When the API request adapts to communication in the first mode, service providing server SP issues the first request via the API to persistent connection server Pe (step S303) and quits the process. When the first request is issued, communication described with reference to FIGS. 6 and 7 is established also in system 100 in the second embodiment.

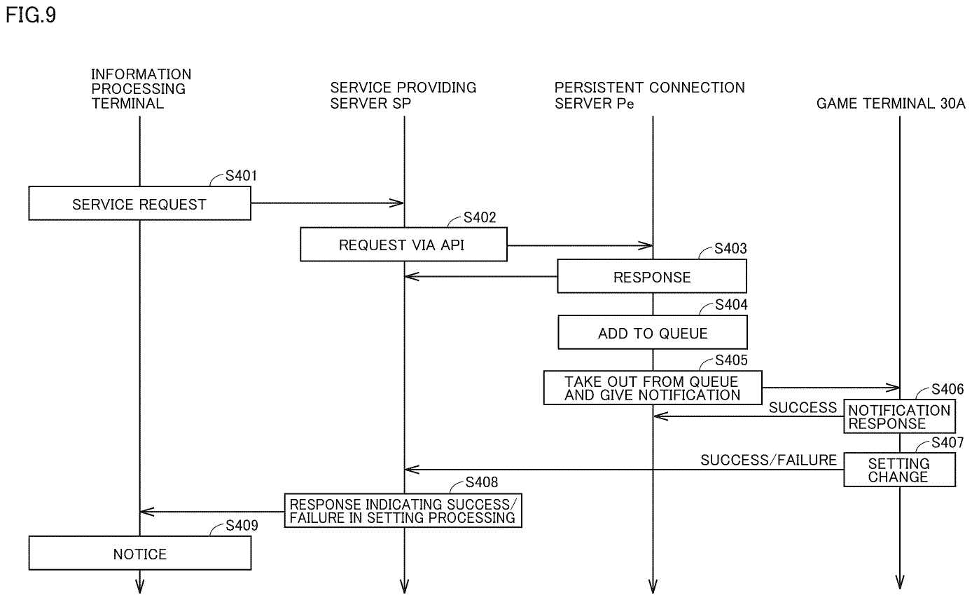

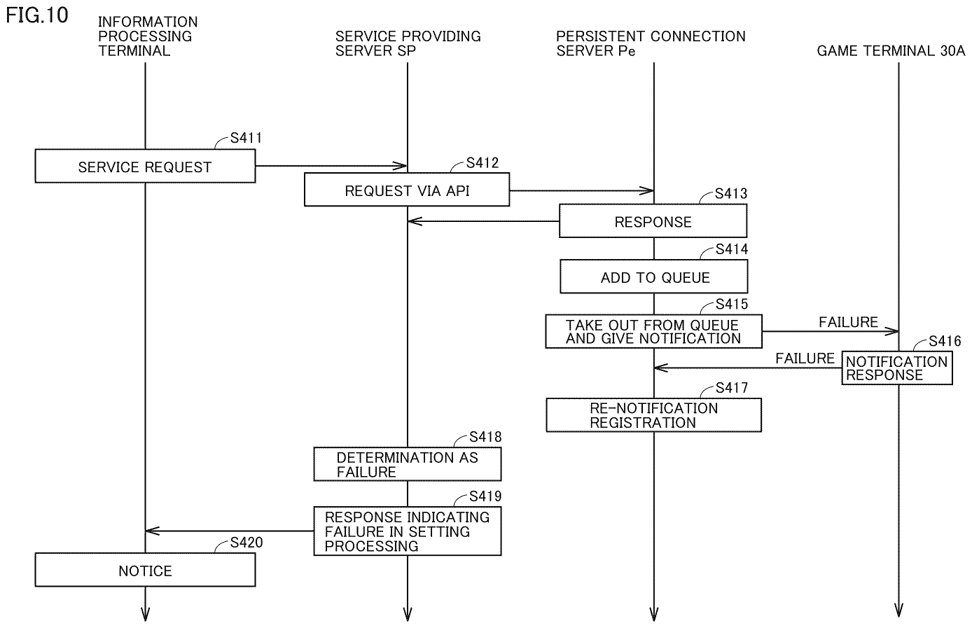

When the API request adapts to communication in the second mode, service providing server SP issues the second request via the API to persistent connection server Pe (step S304) and quits the process. At this time, service providing server SP may transmit to persistent connection server Pe, a re-notification flag in addition to the destination information of game terminal 30 to which the notification is to be sent and contents of the notification. Storage 26 in the second embodiment may further include a re-notification table for holding a notification in which the re-notification flag is TRUE. The re-notification table is a table where a notification to be sent again is stored when notification to game terminal 30 fails in communication in the second mode. When the second request is issued, communication which will be described with reference to FIGS. 9 and 10 is established in system 100 in the second embodiment.

### D. Flow of Processing in Communication in Second Mode

Exemplary communication in the second mode will be described below. An exemplary sequence for illustrating an example in which a notification for causing setting change in communication in the second mode has been successful will be described with reference to FIG. 9. FIGS. 9 and 10 show only communication between game terminal 30A among a plurality of game terminals 30 for which the batch processing is requested and an information processing terminal. The information processing terminal may be a terminal for development of a program by a developer or may be an information processing terminal such as a smartphone, a tablet, or a PC.

The information processing terminal issues a service request for changing setting of the plurality of game terminals 30 including game terminal 30A to service providing server SP (step S401). Service providing server SP determines that the API request corresponding to the service request in step S401 adapts to communication in the second mode, by performing the flowchart in FIG. 8. Service providing server SP transmits the second request based on the service request (step S402). In step S402, service providing server SP transmits to persistent connection server Pe, a data package including the destination information of all game terminals 30 to which the notification is to be sent, contents of the notification indicating an instruction to perform the batch processing, and the re-notification flag that have been described with reference to step S304. Persistent connection server Pe that has received the data package may have the notification stored in the re-notification table when the re-notification flag is TRUE.

Upon reception of the second request, persistent connection server Pe responds to service providing server SP (step S403). Based on completion of the response in step S403 in communication in the second mode, the session between service providing server SP and persistent connection server Pe ends. The response in step S403 does not have to be given, and service providing server SP may quit the session with persistent connection server Pe based on completion of the second request. Persistent connection server Pe adds information in the data package received from service providing server SP to a queue (step S404). The queue may have a data structure, for example, in a first in first out (FIFO) format. A plurality of notifications corresponding to a plurality of respective game terminals 30 to be defined as destinations are successively added to the queue.

Persistent connection server Pe takes out a notification directed to game terminal 30A from the queue and transmits the notification to game terminal 30A (step S405). Processing in step S406 corresponds to the processing in step S204. Since processing in steps S407 to S409 corresponds to the processing in steps S206 to S208, description will not be repeated.

In succession, an exemplary sequence for illustrating an example where notification for causing setting change in communication in the second mode has failed will be described with reference to FIG. 10. Since processing in step S411 to step S415 correspond to the processing in step S401 to step S405, description will not be repeated. In an example in FIG. 10, game terminal 30A does not respond to a notification shown in step S415. In other words, transmission and reception of the notification fail in step S415 for various causes described above.

Game terminal 30A transmits, for example, information indicating failure in reception of the notification (step S416). Persistent connection server Pe determines that game terminal 30A has failed in reception of the notification in processing in step S416. When persistent connection server Pe does not receive the notification response shown in step S416 by the time of lapse of a predetermined period since the notification is given to game terminal 30A in step S415, it may determine that game terminal 30A has failed in reception of the notification. When the re-notification flag in the notification taken out of the queue in step S415 is TRUE, for example, when game terminal 30A is newly normally connected to persistent connection server Pe, persistent connection server Pe transmits the notification again (step S417). In other words, in step S417, persistent connection server Pe sends the notification shown in S415 after it waits for normal connection of game terminal 30A to persistent connection server Pe again.

When a specific condition is satisfied after service providing server SP issued the second request (step S412), service providing server SP determines that setting change has failed (step S418). The specific condition is, for example, not receiving the notification response from game terminal 30A by the time of lapse of a prescribed period. The specific condition may be reception of a response indicating failure in setting change from game terminal 30A. Since processing in steps S419 and S420 corresponds to the example of failure in setting change in the processing in steps S207 and 208, description will not be repeated.

### E. Other Modifications

An upper limit may be set for the number of game terminals 30 to which a notification can simultaneously be sent in response to the first request. In this case, when the first request directed to game terminals 30 more than the upper limit is issued, persistent connection server Pe may automatically perform processing in communication in the second mode.

Service providing server SP may determine whether to issue the first request or the second request based on contents of the service request each time it accepts the service request, rather than to which communication mode the service request adapts being predetermined in accordance with the type of the service request. For example, service providing server SP may determine a corresponding type of the API request in accordance with the number of game terminals 30 to which a notification should be sent in response to the service request. Specifically, when the number of destinations is smaller than a predetermined prescribed number, service providing server SP may determine to issue the first request, and when the number of destinations is equal to or larger than the prescribed number, it may determine to issue the second request. Service providing server SP may selectively use the first request and the second request depending on contents of the service request within the same service. Furthermore, system 100 may include a plurality of service providing servers SP that provide different services, and whether to issue the first request or the second request may be predetermined for each of the plurality of service providing servers.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A system comprising:
a first terminal;
a second terminal;
a first server; and
a second server,
the first server comprising at least one memory storing instructions that, when executed, cause at least one processor of the first server to perform operations comprising performing first processing comprising causing the second server that is configured to persistently be connected to the second terminal to give a first notification to the second terminal, in accordance with a user operation on the first terminal,
the second server comprising at least one memory storing instructions that, when executed, cause at least one processor of the second server to perform operations comprising transmitting to the first server, a second response indicating successful delivery of the first notification or a third response indicating that the first notification has failed, in accordance with whether the second server has received a first response from the second terminal indicating that the second terminal has received the first notification.

2. The system according to claim 1, wherein
the third response comprises information indicating a cause of failure to deliver the first notification.

3. The system according to claim 1, wherein
the operations performed by the at least one processor of the second server comprise, in transmission of the third response to the first server,
transmitting the third response after lapse of a prescribed period when the second terminal is persistently connected to the second server, and
transmitting the third response before lapse of the prescribed period when the second terminal is not persistently connected to the second server.

4. The system according to claim 1, wherein
the operations performed by the at least one processor of the first server comprise
causing the first terminal to give a notice when the first server has received the third response from the second server, and
omitting giving the notice to a user of the first terminal by the first terminal when the first server has received the second response from the second server.

5. The system according to claim 1, wherein
the second terminal is configured such that a virtual game card is insertable therein, and
the first processing comprises processing for insertion of the virtual game card in the second terminal or processing for removal of the virtual game card from the second terminal.

6. The system according to claim 1, wherein
the operations performed by the at least one processor of the first server comprise
performing second processing comprising causing the second server to give a second notification to the second terminal, in accordance with a user operation on the first terminal,
holding a session with the second server when a request is issued to the second server in the first processing, and
quitting the session with the second server when a request is issued to the second server in the second processing.

7. A computer-implemented method comprising:
performing, at a first server, first processing comprising causing a second server that is configured to persistently be connected to a second terminal to give a first notification to the second terminal, in accordance with a user operation on a first terminal;
receiving, at the second server, from the second terminal, a first response indicating that the second terminal has received the first notification; and
transmitting to the first server, at the second server, a second response indicating successful delivery of the first notification or a third response indicating that the first notification has failed, in accordance with whether the second server has received the first response.

8. The computer-implemented method according to claim 7, wherein
the third response comprises information indicating a cause of failure to deliver the first notification.

9. The computer-implemented method according to claim 7, comprising:
in transmission of the third response to the first server at the second server,
transmitting, at the second server, the third response after lapse of a prescribed period when the second terminal is persistently connected to the second server; and
transmitting, at the second server, the third response before lapse of the prescribed period when the second terminal is not persistently connected to the second server.

10. The computer-implemented method according to claim 7, comprising:
causing, at the first server, the first terminal to give a notice when the first server has received the third response from the second server, and
omitting, at the first server, the notice to a user of the first terminal by the first terminal when the first server has received the second response from the second server.

11. The computer-implemented method according to claim 7, wherein
the second terminal is configured such that a virtual game card is insertable therein, and
the first processing comprises processing for insertion of the virtual game card in the second terminal or processing for removal of the virtual game card from the second terminal.

12. The computer-implemented method according to claim 7, comprising:
performing, at the first server, second processing comprising causing the second server to give a second notification to the second terminal in accordance with a user operation on the first terminal;
holding, at the first server, a session with the second server when the second server is requested to perform the first processing; and
quitting, at the first server, the session with the second server based on a fact that the second server is requested to perform the second processing.

13. The computer-implemented method according to claim 12, comprising omitting, at the second server, a notification to the first server that indicates that the second notification has been successful, based on reception of a request for the second processing, even when the second notification has been successful.

14. A non-transitory computer-readable medium storing executable instructions that, when executed, cause at least one processor of a second server to perform operations comprising:
giving a first notification to a second terminal based on first processing performed by a first server, in accordance with a user operation on a first terminal;
receiving from the second terminal, a first response indicating that the second terminal has received the first notification; and
transmitting to the first server, a second response indicating successful delivery of the first notification or a third response indicating that the first notification has failed, in accordance with whether the second server has received the first response.

15. The medium according to claim 14, wherein
the third response comprises information indicating a cause of failure to deliver the first notification.

16. The medium according to claim 14, wherein
the operations comprise
in transmission of the third response to the first server at the second server, transmitting the third response after lapse of a prescribed period when the second terminal is persistently connected to the second server, and
in transmission of the third response to the first server at the second server, transmitting the third response before lapse of the prescribed period when the second terminal is not persistently connected to the second server.

17. The medium according to claim 14, wherein
the second terminal is configured such that a virtual game card is insertable therein, and
the first processing comprises processing for insertion of the virtual game card in the second terminal or processing for removal of the virtual game card from the second terminal.

18. The medium according to claim 14, wherein
the operations comprise
giving a second notification to the second terminal based on second processing performed by the first server, in accordance with a user operation on the first terminal,
holding a session with the first server when a request for the first processing is accepted from the first server, and
quitting the session with the first server when a request for the second processing is accepted from the first server.

19. The medium according to claim 18, wherein
the operations comprise omitting a notification to the first server that indicates that the second notification has been successful, based on reception of the request for the second processing, even when the second notification has been successful.

20. The medium according to claim 18, wherein
the operations comprise omitting adding the first notification to a queue but adding the second notification to the queue.
